(19) United States
(12) Patent Application Publication
(10) Pub. No.: US 2007/0262028 A1
(43) Pub. Date: Nov. 15, 2007

(54) Method and device for magnetically filtering fluids

(75) Inventor: Joseph R. Flaherty, Ansonia, CT (US)

Correspondence Address: Philip J. Lee, Suite 525, 10050 Regency Circle, Omaha, NE, 68114, US

(73) Assignee: The Lee Company

(21) Appl. No.: 11/433,593

(22) Filed: May 12, 2006

(51) Int. Cl. C02F 1/48

(52) U.S. Cl. 210/695; 210/222

(57) ABSTRACT

A method of and device for capturing and retaining magnetic particles from fluids by exposing one or more cylindrical and diametrically polarized magnetic elements to a fluid by means of a device that secures the magnetic element or elements while exposing both magnetic poles of each magnetic element to the fluid to be filtered and positions the magnetic element with the axis of the magnet and the magnetic poles of the element normal to the expected direction of flow within the system to be filtered.

### BACKGROUND OF THE INVENTION

A. Field of Invention

The present invention relates generally to methods and devices for capturing and retaining magnetic particles from fluids and more particularly to new and improved methods of making a magnetic element and of exposing the magnetic element to a fluid by means of a device adapted for that purpose.

B. Description of Related Art

A variety of fluid systems are susceptible to contamination by magnetic particles, for example, lubrication and hydraulic systems. In such systems, a circulating fluid may be in contact with operating mechanisms, which as a result of their operation may create metallic chips or particles, and the chips or particles become suspended in the fluid either by design or as an unavoidable consequence. Removal of such contaminating particles is frequently desired, and conventional removal means include devices that expose a magnetized element to the fluid and using the magnetic attraction of the element to capture the particles. Magnetic particle removal devices are traditionally used in lube oil sumps, gearboxes, transmissions or inline in hydraulic systems with susceptibility to contamination from magnetic particles. Other systems using some form of magnetic particle removal device are outboard marine engines, earthmoving equipment, farm equipment, printing presses, air conditioning compressors, and drilling equipment. Generally, such devices may be referred to as magnetic plugs or self-closing valves, and function to protect critical systems from damage by magnetic particles and could be installed in cross-drilled holes, inline fittings, or reservoir sumps. Magnetic particle removal devices may be as simple as a magnet attached to a drain plug. In some such devices, at least so much of the device as contains the magnetic element may be removed for inspection and cleaning on an application specific maintenance schedule. Visual inspection and metallurgical analysis of the magnetic debris collected, provides valuable information about the wear characteristics of the system. The magnetic element in a self-sealing magnetic valve is commonly a cylindrical permanent magnet with axially oriented magnetic poles, whereby one magnetic pole is at each end. Traditional products use a two-pole Alnico magnet oriented with magnetic poles at both ends such that the flux lines at the poles are generally parallel to the longitudinal axis of the magnet. At least one end of the magnetic element, and therefore at least one magnetic pole, in such conventional devices is used to engage and secure the magnetic element to a retention device, such as a plug, and is therefore not exposed to the system fluid to be filtered. As a result, the conventional device does not expose to the system fluid at least half of the magnetic poles constituting those portions of the surface of the magnetic element that possess the greatest ability to attract and retain magnetic particles from the fluid.

Therefore, there is a need for an improved method and device for improving the removal of magnetic particles from a system fluid in which the particles are suspended, by means of a method of exposing a greater area of the magnetic poles of a magnetic element to the system fluid to be filtered by constructing and installing a device that supports a removable magnetic element having a substantial portion of both magnetic poles exposed to the system fluid. A further need exists for use of such a device that is readily and safely removed for inspection or maintenance without loss of system fluid.

### SUMMARY OF THE INVENTION

The method of the present invention comprises forming and using structurally improved magnetic filtering devices by using cylindrical magnetic elements that are diametrically polarized and maximizing the exposure of the magnetic poles of such elements to the fluid to be filtered by supporting one end of the element and exposing a substantial portion of both magnetic poles of the element. Specifically, the present invention utilizes recent advances in magnetic materials and the magnetizing capabilities of these materials in improved device designs. The devices of the present invention support magnetic elements and expose said elements to the fluid of a fluid system from which magnetic particles and debris are to be removed, with the surfaces of the element comprising the magnetic poles of the element aligned generally perpendicular to the direction of expected flow.

The magnetic element of the present invention is preferably formed of Neodymium Iron Boron, a rare earth magnetic material; although other suitable materials may also be used. The present invention uses one or more Neodymium permanent magnets that are cylindrical and are diametrically polarized such that orientation of magnetic flux is perpendicular to the longitudinal axis of the cylindrical magnetic element. The pattern of polarization of the elements results in at least two magnetic poles that are linear and extend from one cylinder end to the other on the curved side surface of the element. Therefore the diametrically magnetized magnetic element most forcefully attracts particles to its circumferential surface as opposed to the conventionally magnetized magnetic element that most strongly attracts particles to its end surfaces, which are at least partially shielded from the system fluid in the conventional device by contact with the supporting structure. The device of the present invention supports the magnetic element by at least one end and exposed a substantial portion of the element circumferential surfaces to the system fluid, including a substantial portion of both magnetic poles. The diametric polarity of the magnetic elements provides an advantage by allowing the exposure of a greater amount of the magnetic pole surface to the fluid to be filtered.

It may be possible and advantageous in larger embodiments to provide multiple polarity, with multiple sets of magnetic dipoles arranged in a radial or other pattern; however, in the relatively small magnet diameters used in the illustrated preferred embodiment, for example about 0.25 inches or less, a single set of dipoles separated by the diameter of the magnet are found to be sufficient. At least a minimal separation of opposite poles seems useful and provides a flux configuration that is useful in capturing magnetic particles from the surrounding fluid media.

A first preferred embodiment of a device performing the method of the present invention is designed to be inserted into a flow passage or chamber from outside the fluid system to be filtered. A self-sealing magnetic filter device is constructed in which a magnetic element or a sleeve containing a magnetic element forcibly lifts a sealing poppet off a valve seat against the force of a spring such that the magnetic element is exposed to the system fluid and when the magnetic element is removed, the poppet reseats and seals the valve. The advantage of the self-sealing valve design is that when the magnetic element is removed during inspection and cleaning, the poppet reseals the opening and only a small amount of fluid escapes from the system. The first embodiment comprises a body, a poppet, a magnetic element and a retaining member. The body comprises a hexagonal outer end, an inner section, and an externally threaded portion, coaxial with the body generally and between the outer end and the inner section, the externally threaded section providing means for installing the device in a threaded opening to a flow passage or chamber. The body is designed to be installed by engagement of the externally threaded section within an internally threaded opening into the fluid system to be filtered. The body further forms a central axial bore, and a portion of the central bore proximate to the outer end is internally threaded to accept an externally threaded magnetic element retaining member. The inner section of the body is generally open to the system fluid by means of lateral open sections but is transversely closed at the innermost end to provide for the support of the poppet and a poppet biasing spring. The open sections of the body may be formed by cutting away substantial portions of the sidewall of an initially cylindrical body section, but other manufacturing processes can be used as well. The magnetic element retaining member comprises an outer end adapted to receive rotational force for driving the retaining member into the central bore of the body in a first direction toward the innermost end of the body. The magnetic element retaining member comprises a sleeve section sized to receive a cylindrical magnetic element within the sleeve wall, the innermost end of which is crimped after the magnetic element is installed within the sleeve to retain the magnetic element therein. Other methods can be used to secure the magnetic element such as gluing or mechanical retention within a socket that does not cover the magnetic poles on the sides of the magnetic element. The use of a protective sleeve serves to protect the magnetic element and does not unduly diminish the effectiveness of the device provided the sleeve is formed of non-magnetic material. The retaining member sleeve section projects in the first inward direction from the retaining member outer end and is aligned such that the magnetic element projects coaxially within the central bore when the retaining member is threaded into the device body. The installation bore into which the device is installed perpendicularly intercepts a flow passage within the system to be filtered. An annular valve seat seal is formed by the device body and is located within the central bore in an intermediate position between the inner section openings and the outer end. A poppet is retained within the central bore between the valve seat and the closed inner end of the device body. The poppet is biased in a second axial direction toward the valve seat and the outer end of the body by a spring compressed between the poppet and the closed inner body end. In the absence of the magnetic element, the poppet engages the valve seat to seal the central bore and prevent system fluid from passing outward through the device central bore, preventing the escape of fluid from the system. The poppet is advantageously brightly colored and will be visible through the open outer end of the device body when the magnetic element and the retaining member are removed from the body, thereby providing a readily apparent alert that the magnetic element is not installed. When the magnetic element retaining member is screwed into the body, the inner end of the magnetic element retaining sleeve engages the poppet, compressing the poppet spring and separating the poppet from the valve seat, and the magnetic element advances into the portion of the central bore to become in communication with the system fluid. The poppet head comprises a generally flat disc with a central raised portion of a diameter significantly less than that of the magnetic element.

A second preferred embodiment of a device employing the method of the present invention is an inline device designed to be installed within, and coaxially aligned with, a flow passage through which the system fluid passes. The inline device comprises an outer surface adapted to be securely inserted into a tube, for example by external screw threads. For ease in removal, the inline device is preferably installed proximate to a break in the tube. The inline device comprises a central bore and a sleeve sized to slide into the central bore. The sleeve is tubular with a thin cylindrical wall in which two sets of diametrically opposing circular openings are formed. Each set of opposed openings are axially displaced from each other and rotated ninety degrees from each other. Two rod shaped magnetic elements are installed in the sleeve with each element end secured within one of the opposing wall openings such that the magnetic elements diametrically traverse the sleeve and are arrayed at ninety degrees from each other. The fluid to be filtered flows generally through the sleeve and the magnetic elements are aligned perpendicularly to that flow direction. The central bore comprises a section having an inner diameter sufficient to receive the sleeve and a section of decreased inner diameter, forming a sleeve retaining shoulder and the sleeve receiving section comprises an annular groove surrounding the bore, sized to receive a removable retaining ring. The sleeve with installed magnetic elements is secured within the device bore by the shoulder at one end and the retaining ring inserted within at the other end. For inspection and/or cleaning, the retaining ring and sleeve are removed. The magnetic rods are formed of Neodymium Iron Boron and are magnetized with diametrically separated magnetic dipoles as described above and may be encased in a protective tube of non-magnetic material.

The principle aim of the present invention is to provide a new and improved method and device that meets the foregoing requirements and is capable of capturing and retaining magnetic particles from a fluid system. Another and further object and aim of the present invention is to provide a new and improved method and device that meets the foregoing requirements and which exposes a substantial portion of both of the magnetic poles of diametrically polarized rod magnets to the system fluid.

Other objects and advantages of the invention will become apparent from the Description of the Preferred Embodiments and the Drawings and will be in part pointed out in more detail hereinafter.

The invention consists in the features of construction, combination of elements and arrangement of parts exemplified in the construction and method as hereinafter described.

### BRIEF DESCRIPTION OF THE DRAWINGS

FIG. 1 is a longitudinal section view of a first preferred embodiment of a device in accord with the present invention.

FIG. 2 is a first end view of a first preferred embodiment of a device in accord with the present invention.

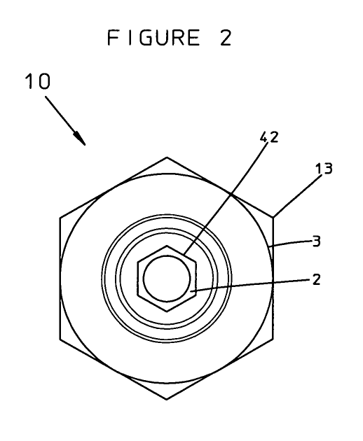

FIG. 3 is a side view of a first preferred embodiment of a device in accord with the present invention.

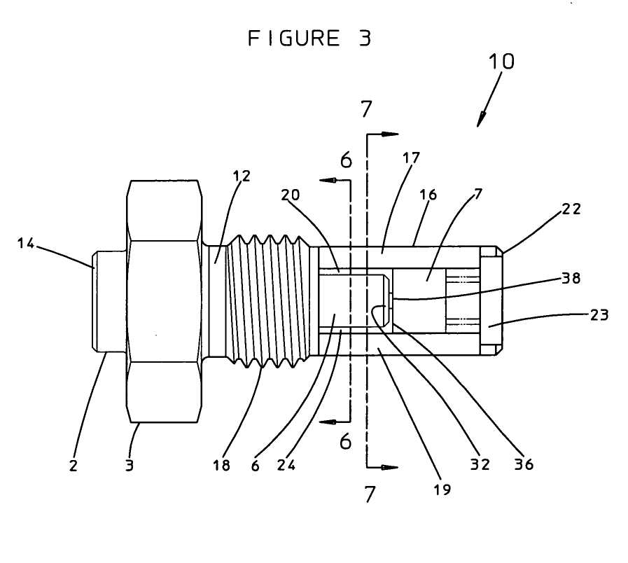

FIG. 4 is a side view of a first preferred embodiment of a device in accord with the present invention, the device shown rotated 90 degrees from the view of FIG. 3.

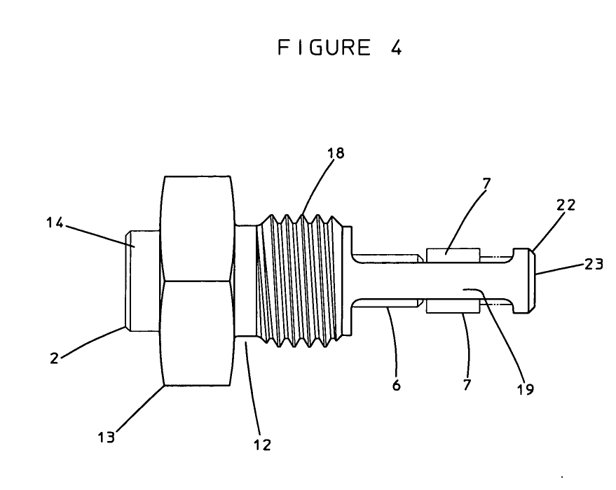

FIG. 5 is a longitudinal section view of an installation bore for installation of a first preferred embodiment of a device in accord with the present invention.

FIG. 6 is a cross sectional view of a first preferred embodiment of a device in accord with the present invention, taken through the line 6-6 shown in FIG. 3.

FIG. 7 is a cross sectional view of a first preferred embodiment of a device in accord with the present invention, taken through the line 7-7 shown in FIG. 3.

FIG. 8 is a longitudinal section view of a second preferred embodiment of a device in accord with the present invention.

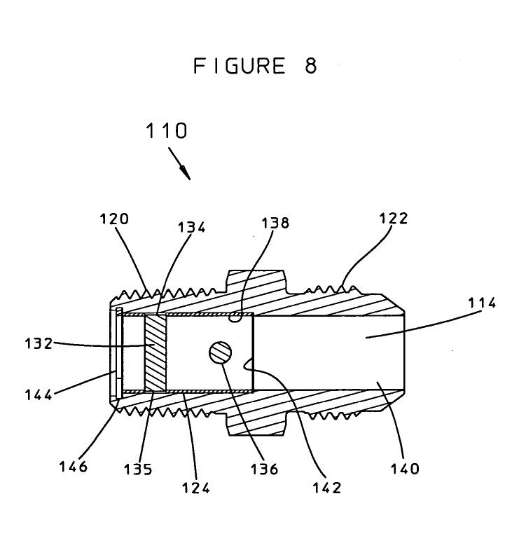

FIG. 9 is an end view of a second preferred embodiment of a device in accord with the present invention.

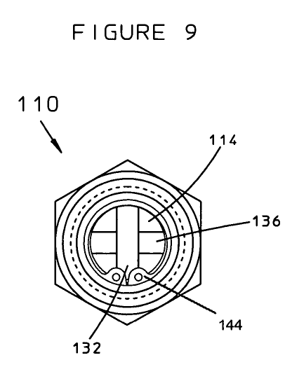

FIG. 10 is a longitudinal section view of a magnet-retaining sleeve of a second preferred embodiment of device in accord with the present invention.

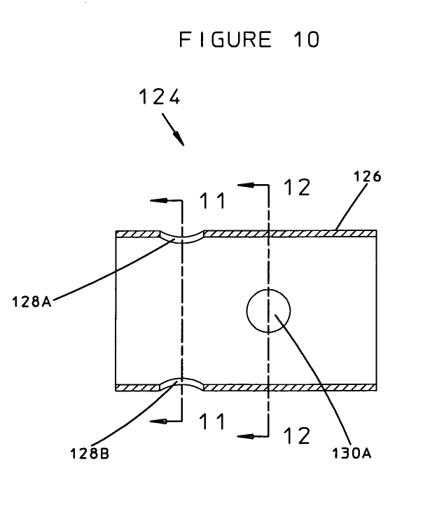

FIG. 11 is a cross section view of a magnet-retaining sleeve of a second preferred embodiment of a device in accord with the present invention taken at line 11-11 in FIG. 10.

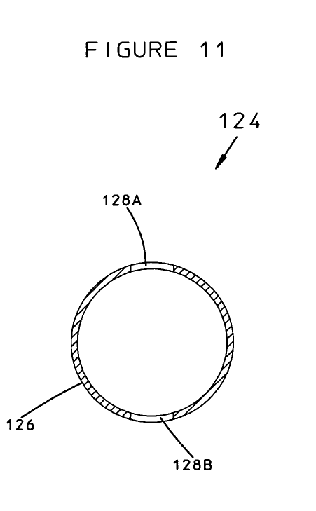

FIG. 12 is a cross section view of a magnet-retaining sleeve of a second preferred embodiment of a device in accord with the present invention taken at line 12-12 in FIG. 10.

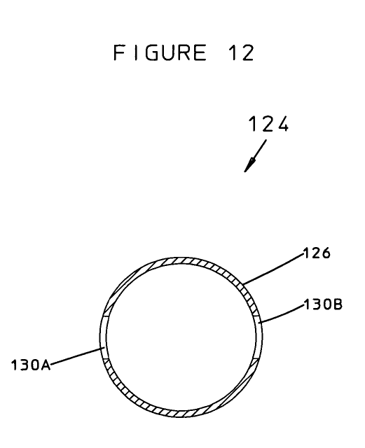

### DESCRIPTION OF THE PREFERRED EMBODIMENT(S)

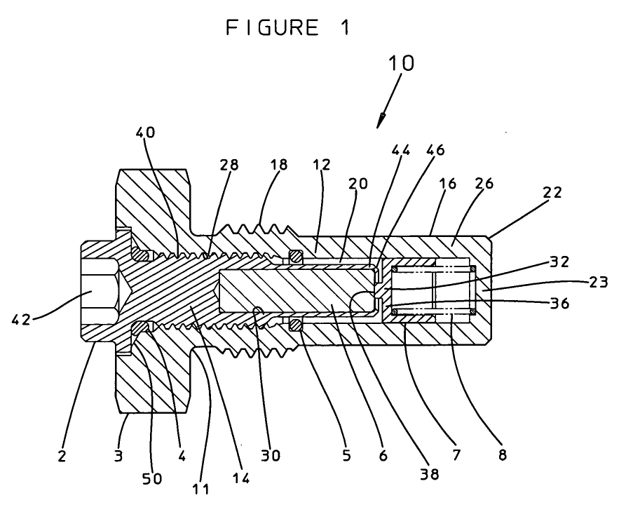

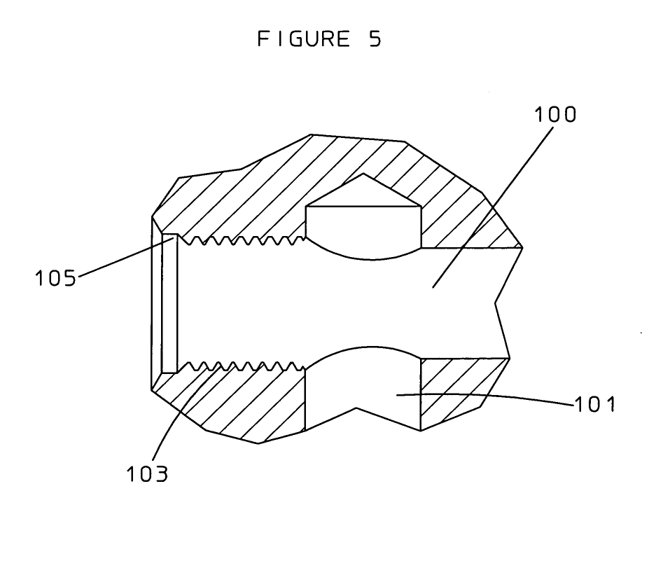

With reference to the Drawing wherein like numerals represent like parts, a first preferred embodiment of a device constructed to carry out the method of the present invention is generally designated by numeral 10 in FIG. 1. Device 10 is intended to be installed by partial insertion into an installation bore, an example of which is shown in FIG. 5 and designated by the numeral 100, and the term inner or inward is used herein to reference the area or direction toward the interior of bore 100 and the terms outer or outward are used herein to reference the area or direction toward the exterior of bore 100. The inward direction may also be called the first direction and the outward direction may also be called the second direction. Installation bore 100, shown as an example only and not as a limitation of the invention, preferably intercepts a section of the flow passage 101 of the system to be filtered and comprises internal screw threads 103 and an outer shoulder 105.

Device 10 comprises a body 12, a poppet 7, a magnetic element 6 and a retaining member 14. The body 12 comprises an outer end 3 and an inner end 22, outer end 3 having a hexagonally shaped section 13 and an inner section 16 formed adjacent to inner end 22. An externally threaded portion 18 is located between hexagonal outer end section 13 and the inner section 16. Externally threaded portion 18 provides means for securing device 10 in a threaded installation bore 100 by engagement with internally threaded section 103. Hexagonal section 13 is of greater outer dimension than threaded portion 18 thereby forming an annular shoulder 11 on the side of hexagonal section 13 facing toward inner end 22, and an outer annular seal may be used to surround body 12 adjacent to and between shoulder 11 and shoulder 105 of the installation bore 100. Device body 12 further comprises a central axial bore 20, transversely closed at body inner end 22. Inner section 16 is formed as an originally tubular shape with a wall 26 that is cut away on two opposing sides in longitudinally extending sections, creating openings 24 and 25 and leaving diametrically opposed support and guide members 17 and 19. Guide members 17 and 19 extend to and are joined at inner end 22 by a transverse end 23, and serve to support and guide poppet 7. Openings 24 and 25 provide fluid communication between the central bore 20 and the area of the fluid system into which device 10 is installed, adjacent to and surrounding inner section 16. Transverse end 23 closes central bore 20 at inner end 22 and serves as a stop for a spring 8 placed between poppet 7 and transverse end 23.

A portion 28 of the central bore 20 proximate to the outer end 3 is internally threaded to accept an magnetic element retaining member 14 having an externally threaded section 40 sized to engage the internal screw threads of internally threaded bore portion 28. The magnetic element retaining member 14 comprises an outer end 2 adapted by means of a hexagonal socket 42 to receive a wrench for applying rotational force to member 14. The engagement of the externally threaded section 40 with the internally threaded bore portion 28 drives retaining member 14 into the body central bore 20 in a first direction, toward inner body end 22. Magnetic element retaining member 14 further comprises a magnetic element receiving socket 30 at the inner end 44 opposite to outer end 2. The retaining member socket 30 is shaped as an axially extending sleeve and is sized to securely receive a cylindrical magnetic element 6 aligned coaxially within the central bore 20. The depth of socket 30 is greater than the length of magnetic element 6 and after the element 6 is fully inserted into socket 30, a portion 46 of the wall of socket 30 extends past the end of element 6 at inner end 44 and is swaged radially inwardly to partially enclose and securely retain element 6 within socket 30. At least so much of member 14 as constitutes the wall of socket 30 surrounding magnetic element 6 is formed of a non-magnetic material such as plastic or non-ferrous metal to allow the magnetic field to extend into the surrounding fluid. It will be anticipated that alternative methods and structures for securing magnetic element 6 are possible, such as using a short socket with a bonding agent such as epoxy holding element 6 in place or crimping the socket wall to mechanically bind element 6, in which case, socket 30 need not extend the length of element 6.

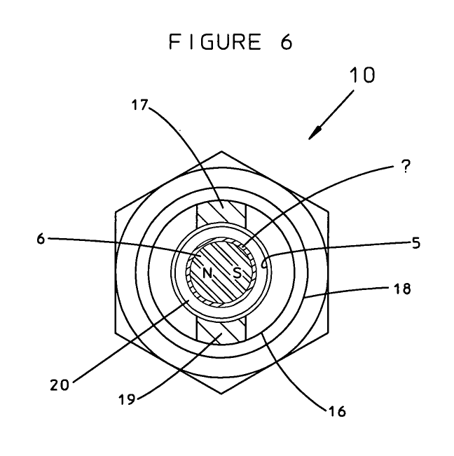

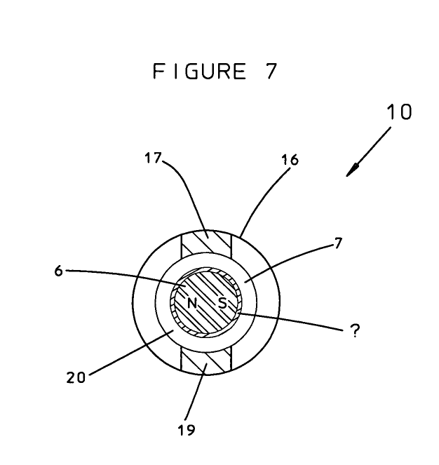

Magnetic element 6 is a cylinder formed of Neodymium with permanent magnetization oriented in a diametrical pattern such that orientation of magnetic flux is perpendicular to the longitudinal axis of the cylindrical magnetic element 6, and has diametrically opposed magnetic poles on the surface of the cylindrical sides of magnetic element 6. The magnetic poles, designated in FIGS. 6 and 7 by the letters N and S representing the conventionally referenced north and south magnetic poles, extend linearly over the length of element 6, on opposite sides of element 6 and parallel to the axis of magnetic element 6 and to the axis of device 10 in general. Retaining member externally threaded section 40 is located between outer end 2 and socket 30 such that when retaining member 14 is fully screwed into body 12, socket 30 and magnetic element 6 are adjacent to openings 24 and 25 and are exposed to system fluid flowing through body openings 24 and 25. Device 10 is preferably installed in an installation bore 100 that perpendicularly intercepts a flow passage 101 of the system to be filtered as shown in FIG. 5, such that device 10 and magnetic element 6 are aligned perpendicular to the direction of expected flow within the system, flow being expected to proceed generally coaxially within passage 101. An annular valve seat seal 5 is located within the central bore 20 of body 12 in an intermediate position between the inner section openings 24 and 25 and the internally threaded portion 28. Poppet 7 is cylindrical and sized to be slidingly retained within central bore 20 between the valve seat 5 and the inner transverse end 23 of device body 12. The head surface 36 of poppet 7 comprises a generally flat disc with a central raised portion 38 of a diameter significantly less than the diameter of inner end 44 of magnetic element retaining member 14. Poppet 7 is biased in a second axial direction toward valve seat 5 by spring 8 compressed between poppet 7 and the inner transverse end 23. When the magnetic element retaining member 14 is not installed, poppet 7 contacts seal 5 and when retaining member 14 is installed and driven in the first, inward direction, inner end 44 contacts poppet 7, which is forced in the first direction away from valve seat seal 5, compressing spring 8, and when member 14 is withdrawn from the device body 12, poppet 7 is allowed to be moved by expansion of spring 8 in the second direction until poppet 7 engages valve seat 5. The engagement of poppet 7 with valve seat 5 seals the central bore 20 and prevents system fluid from passing through device central bore 20 in the second direction, preventing the escape of fluid from the system. Poppet 7 is preferably vividly colored and is visible from the device outer end 3 when the magnetic element 6 is not installed, providing a readily apparent visual indication that the magnetic element 6 is not installed. When the magnetic element retaining member 14 is screwed into device body 12, the inner end 32 of the magnetic element 6 engages poppet 7 and separates poppet 7 from valve seat 5, and the magnetic element 6 advances into the portion of central bore 20 in communication with the system fluid. When the magnetic element retaining member 14 is fully advanced into the device body, an inner annular seal 4 surrounding the outer opening of the central bore 20 is compressed between the body outer end 3 and a shoulder 50 formed at the outer end of the retaining member 14, thereby sealing the central bore 20.

A second embodiment of a device employing and constructed in accordance with and for use in carrying out the method of the present invention is generally designated by numeral 110 in FIGS. 5 and 6. Device 110 is generally cylindrical with a central axial bore 114 and comprises an outer surface adapted to be securely inserted into a flow passage (not shown) by two sets of external screw threads 120 and 122 at either end. In the installed device 110, the device 110 and the central bore 114 are aligned coaxially with the direction of expected flow within the flow passage. Device 110 further comprises a sleeve 124 sized to slide into the central bore 114. Sleeve 124 is tubular with a thin cylindrical wall 126 in which two sets of diametrically opposing circular openings 128A and 128B, and 130A and 130B are formed. Opposed openings 128A and 128B are axially displaced from and rotated ninety degrees from opposed openings 130A and 130B. A rod shaped magnetic element 132 with ends 134 and 135 is installed in sleeve 124 with each end 134 or 135 secured within one of the opposing openings 128A and 128B such that magnetic element 132 diametrically traverses central bore 114 and a second magnetic element 136 is similarly installed in opposed openings 130A and 130B. Installed magnetic elements 132 and 136 are axially separated and arrayed at ninety degrees from each other relative to the axis of sleeve 124 and are positioned perpendicularly to the direction of expected flow within the system to be filtered. The wall of central bore 114 comprises a section 138 having a radially inner surface of diameter sufficient to receive sleeve 124 and a section 140 of decreased inner diameter, the transition from section 138 to decreased diameter section 140 forming a shoulder 142 that faces in a first direction toward section 138. The inner wall of section 138 comprises an annular groove 146, which surrounds central bore 114, is sized to receive a removable retaining ring 144 and is axially displaced from shoulder 142 by a distance at least equal to the axial length of sleeve 124. Retaining ring 144 is a split annular spring of similar configuration retainable and removable from groove 146 and with an inside diameter less than the outside diameter of sleeve 124. After magnetic elements 132 and 136 are secured within sleeve 124, sleeve 124 is inserted into bore section 138 until stopped by shoulder 142 and retaining ring 144 is inserted into groove 146, thereby retaining sleeve 124 within bore 114. Magnetic elements 132 and 136 are cylindrical rods formed of Neodymium Iron Boron and are magnetized with diametrically separated magnetic dipoles as described above with respect to the first preferred embodiment. Magnetic elements 132 and 136 may be encased in protective sleeves, not shown, formed of a suitable non-magnetic material. It will be anticipated that device 110 can be used and will be expected to function similarly in a range of linear flow passages and is not limited to use within a tubular section, with minor changes to the outer surface perhaps required.

It will be appreciated that the exact number and array pattern of the magnetic elements in the second preferred embodiment may vary to accommodate a variety of design factors, such as desired flow impedance, flow velocity, and desired rate of particle capture, without departing from the spirit and the scope of the present invention. It will further be anticipated that means other than the illustrated screw threads are known and may be employed to secure either device 10 or 110 within the system without changing the essence of the devices or method described herein.

The method of the present invention includes exposing one or more rod shaped magnetic and diametrically polarized elements to the fluid media of a system to be filtered by means of devices such as devices 10 and 110, that align the magnetic elements such that the both magnetic poles are exposed to the fluid and the linear magnetic poles are generally perpendicular to the direction of expected flow of the fluid to be filtered. The method can include periodic removal of the magnetic elements for inspection and/or cleaning, which can be readily carried out using devices 10 or 110. The method also includes configuring the device such that the installation and removal of the magnetic element is facilitated and allowed without removal of the entire device. The method includes using the magnetic element to displace a poppet, and using the poppet to reseal the fluid system when the magnetic element is removed, and coloring the poppet and positioning the poppet to be readily viewed when the magnetic element is removed.

While preferred embodiments of the foregoing invention have been set forth for purposes of illustration, the foregoing description should not be deemed a limitation of the invention herein. Accordingly, various modifications, adaptations and alternatives may occur to one skilled in the art without departing from the spirit and the scope of the present invention.

1. A method of using a magnetized element to capture magnetic particles comprising forming at least one magnetized element, securing the magnetic element within a first device, installing the first device in a fluid system, and exposing the fluid to be filtered to the fields of both magnetic poles of the magnetic element.

2. The method of claim 1 wherein at least one magnetic element is formed to be cylindrical and is magnetized to be diametrically polarized with linear magnetic poles extending the length of the magnetic element on opposing sides thereof.

3. The method of claim 2 further comprising forming a second device for positioning the first, element securing device within the fluid system such that the linear magnetic poles of the magnetic element are aligned perpendicular to the direction of expected flow within the system.

4. The method of claim 3 further comprising the step of removal of the magnetic elements for inspection and/or cleaning.

5. The method of claim 4 wherein the step of forming the second device further comprises forming means for sealing the fluid system when the magnetic element is removed.

6. The method of claim 5 further comprising providing a visual signal that the magnetic element is not installed when the magnetic element has been removed.

7. The method of claim 6 wherein the visual signal comprises a poppet that is visible from outside the second device and that seats on a valve seat and seals the fluid system when the magnetic element is removed.

8. The method of claim 3 wherein a plurality of magnetic elements are serially arrayed and secured by the first device.

9. A magnetic filter device for using a magnetized element to capture magnetic particles from a fluid system, the filter device comprising at least one cylindrical and diametrically magnetized element having two opposing ends and at least one pair of linear magnetic poles extending from one end to the other, and at least one first body section comprising means for securing at least one end of each magnetic element.

10. The magnetic filter device of claim 9 wherein each magnetic pole of each pair of magnetic poles of the magnetic element extend the length of the magnetic element on opposing sides thereof.

11. The magnetic filter device of claim 10 further comprising a second body section comprising means for removably engaging the first body section and for positioning the first body section within the fluid system such that at least a substantial part of each of the linear magnetic poles of the magnetic element are exposed to the fluid to be filtered

12. The magnetic filter device of claim 11 wherein the magnetic element is positioned by the first and second body sections to be perpendicular to the direction of expected flow within the fluid system.

13. The magnetic filter device of claim 12 wherein the second device further comprises means for sealing the fluid system when the magnetic element is removed.

14. The magnetic filter device of claim 13 wherein the sealing means further comprises a visual signal visible from outside the fluid system only when the magnetic element has been removed from the second device.

15. The magnetic filter device of claim 14 wherein the sealing means comprises a valve seat formed in the second body section and a poppet that seats on a valve seat and seals the fluid system when the magnetic element is removed.

16. The magnetic filter device of claim 15 wherein the poppet is visible from outside the fluid system and the second body section when the magnetic element is removed from the second body section.

17. The magnetic filter device of claim 15 wherein the poppet is brightly colored.

18. The magnetic filter device of claim 12 wherein a plurality of magnetic elements are serially arrayed and secured by the first body section.

19. The magnetic filter device of claim 18 wherein the first body section is cylindrically shaped with a central axis and the magnetic elements are arrayed perpendicularly to the central axis.

20. The magnetic filter device of claim 19 wherein the magnetic elements are arrayed perpendicularly to each other.
